(19) United States
(12) Patent Application Publication
(10) Pub. No.: US 2022/0326678 A1
(43) Pub. Date: Oct. 13, 2022

(54) REAL TIME DETECTION AND REACTION TO ANOMALIES IN THREADED CONNECTION MAKE-UP

(71) Applicant: WEATHERFORD TECHNOLOGY HOLDINGS, LLC, Houston, TX (US)

(72) Inventors: Benjamin SACHTLEBEN, Hannover (DE); David GEISSLER, Hannover (DE); Christina HEBEBRAND, Hannover (DE); Rainer RUEHMANN, Hannover (DE)

(21) Appl. No.: 17/229,212

(22) Filed: Apr. 13, 2021

(51) Int. Cl. G05B 19/18

(52) U.S. Cl. CPC G05B 19/182; G06N 20/00

(57) ABSTRACT

A method of making-up a threaded connection can include rotating a tubular, measuring torque applied to the tubular during the rotating, thereby generating data including measured torque values, detecting an anomalous occurrence in the data during the rotating, and ceasing application of the torque to the tubular in response to detection of the anomalous occurrence. A threaded connection make-up system can include a rotary clamp to apply torque to a tubular, a torque sensor to produce measurements of the applied torque, and a control system including a neural network, an artificial intelligence device, machine learning and/or genetic algorithms trained to detect an anomalous occurrence in data input to the control system. The data may include the applied torque and turns of the tubular as measured by a turn sensor.

### BACKGROUND

This disclosure relates generally to equipment utilized and operations performed in conjunction with a subterranean well and, in an example described below, more particularly provides for improved threaded connection make-up.

Various types of tubular components can be threaded together to form tubular strings for use in a well. Tubulars used in wells can include protective wellbore linings (such as, casing, liner, etc.), production or injection conduits (such as, production tubing, injection tubing, screens, etc.), drill pipe and drill collars, and associated components (such as tubular couplings).

It is typically important for threaded connections between tubulars to be properly made-up. For example, when a threaded connection is properly made-up, the threaded connection may prevent leakage of fluid into or out of the tubular string, or may resist unthreading of the connection.

It will, therefore, be readily appreciated that improvements are continually needed in the art of making-up threaded connections in tubular strings. The present disclosure provides such improvements to the art.

### BRIEF DESCRIPTION OF THE DRAWINGS

FIG. 1 is a representative partially cross-sectional view of an example of a system and associated method which can embody principles of this disclosure.

FIGS. 2A & 2B are representative side views of an example of a threaded connection in respective partially made-up and fully made-up configurations.

FIG. 3 is a representative schematic view of an example of a control system that may be used to control the threaded connection make-up.

FIG. 4 is a representative graph of an example of torque versus time data for a threaded connection make-up.

FIG. 5 is a representative graph of an example of an anomalous torque versus time data for a threaded connection make-up.

FIG. 6 is a representative flow chart for an example of a method of making-up a threaded connection.

FIG. 7 is a representative side view of another example of a threaded connection in a fully made-up configuration.

FIG. 8 is a representative graph of an example of torque versus turn data for a threaded connection make-up.

FIG. 9 is a representative graph of an example of an anomalous torque versus turn data for a threaded connection make-up.

### DETAILED DESCRIPTION

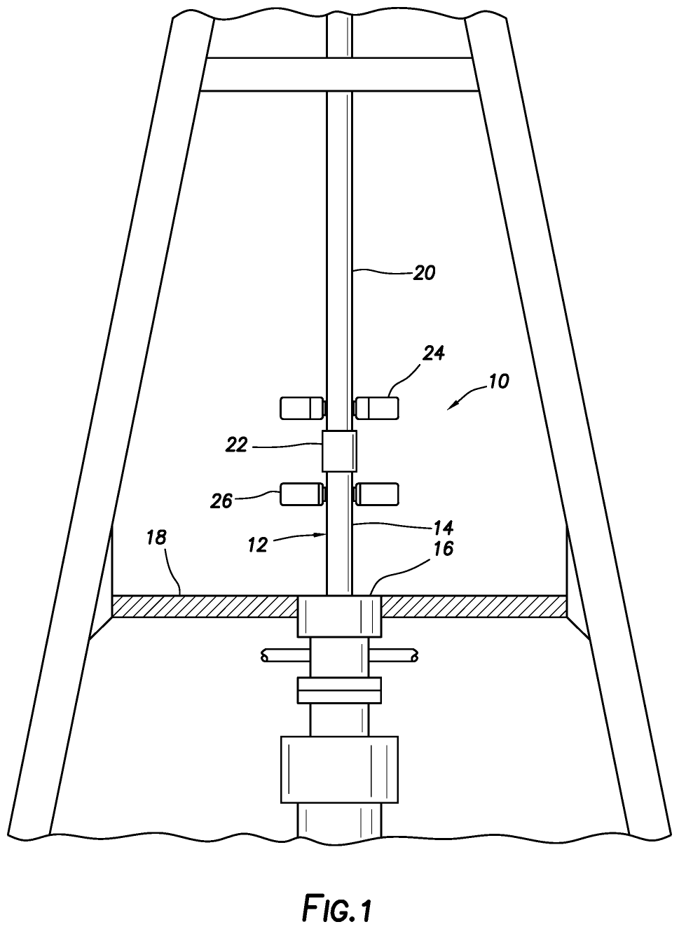

Representatively illustrated in FIG. 1 is a system 10 for use with a subterranean well, and an associated method, which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a tubular string 12 is being assembled and deployed into a well. The tubular string 12 in this example is a production or injection tubing string, but in other examples the tubular string could be a casing, liner, drill pipe, completion, stimulation, testing or other type of tubular string. The scope of this disclosure is not limited to use of any particular type of tubular string, or to any particular tubular components connected in a tubular string.

As depicted in FIG. 1, a tubular 14 is suspended near its upper end by means of a rotary table 16, which may comprise a pipe handling spider and/or safety slips to grip the tubular 14 and support a weight of the tubular string 12. In this manner, the upper end of the tubular 14 extends upwardly through a rig floor 18 in preparation for connecting another tubular 20 to the tubular string 12.

In this example, a tubular coupling 22 is made-up to the upper end of the tubular 14 prior to the tubular 14 being connected in the tubular string 12. The coupling 22 is internally threaded in each of its opposite ends.

In conventional well operations, it is common for a threaded together tubular and coupling to be referred to as a “joint” and for threaded together joints to be referred to as a “stand” of tubing, casing, liner, pipe, etc. However, in some examples, a separate coupling may not be used; instead one end (typically an upper “box” end of a joint) is internally threaded and the other end (typically a lower “pin” end of the joint) is externally threaded, so that successive joints can be threaded directly to each other.

Thus, the scope of this disclosure can encompass the use of a separate coupling with a tubular, or the use of a tubular without a separate coupling (in which case the coupling can be considered to be integrally formed with, and a part of, the tubular). In the FIG. 1 example, the coupling 22 can also be considered to be a tubular, since it is a tubular component connected in the tubular string 12.

To make-up a threaded connection between the tubular 20 and the coupling 22, a set of tongs or rotary and backup clamps 24, 26 are used. The rotary clamp 24 in the FIG. 1 example is used to grip, rotate and apply torque to the upper tubular 20 as it is threaded into the coupling 22.

The backup clamp 26 in the FIG. 1 example is used to grip and secure the lower tubular 14 against rotation, and to react the torque applied by the rotary clamp 24. The rotary clamp 24 and the backup clamp 26 may be separate devices, or they may be components of a rig apparatus known to those skilled in the art as an “iron roughneck.”

In one example, the rotary clamp 24 and backup clamp 26 may be components of a tong system, such as the VERO™ tong system marketed by Weatherford International, Inc. of Houston, Tex. USA. In this example, the rotary clamp 24 may be a mechanism of the tong system that rotates and applies torque to the upper tubular 20, and the backup clamp 26 may be a backup mechanism of the tong system that reacts the applied torque and prevents rotation of the lower tubular 14. Thus, the term “rotary clamp” as used herein indicates the rotation and torque application mechanism, and the term “backup clamp” as used herein indicates the torque reacting mechanism.

Note that it is not necessary for the tubulars 14, 20 (and coupling 22, if used) to be vertical in the tubular make-up operation. The tubulars 14, 20 could instead be horizontal or otherwise oriented. Additional systems in which the principles of this disclosure may be incorporated include the CAM™, COMCAM™ and TORKWRENCH™ bucking systems marketed by Weatherford International, Inc.

In other examples, a top drive (not shown) may be used to rotate and apply torque to the upper tubular 20. Thus, it will be appreciated that the scope of this disclosure is not limited to use of any particular equipment to grip, rotate, apply torque to, or react torque applied to, any tubular in a threaded connection make-up operation.

After the upper tubular 20 is properly made-up to the lower tubular 14 or coupling 22, the tubular string 12 can be lowered further into the well, and the make-up operation can be repeated to connect another stand to the upper end of the tubular string. In this manner, the tubular string 12 is progressively deployed into the well by connecting successive stands to the upper end of the tubular string. In some examples, an individual tubular component may be added to the tubular string 12, instead of a stand.

In the FIG. 1 method, the threaded connection make-up process can be controlled, so that a properly made-up connection is obtained, and this control can be automatic, so that human error is avoided. As described more fully below, a torque sensor can be used in certain examples to facilitate this automatic control of the threaded connection make-up process. In other examples, a turn sensor and/or other sensors may also be used to facilitate the automatic control of the threaded connection make-up process.

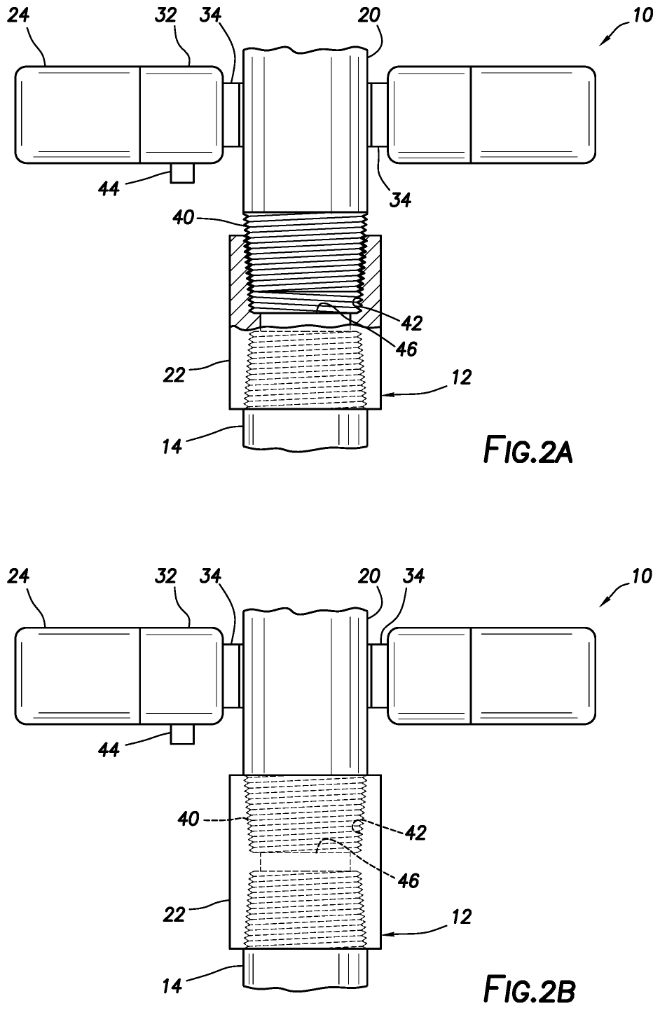

Referring additionally now to FIGS. 2A & B, a first example of the method of making-up tubular string components is representatively illustrated. For convenience, various examples of the method are described below as they may be used with the system 10 of FIG. 1, but the methods may be used with other systems in keeping with the principles of this disclosure.

As depicted in FIG. 2A, the threaded connection make-up process has been initiated. The tubular 20 is positioned above and axially aligned with the coupling 22, with the rotary clamp 24 appropriately positioned to grip an outer surface of the tubular 20. The backup clamp 26 (see FIG. 1) can grip an outer surface of the tubular 14 to react torque applied during the threaded connection make-up process.

Threads 40 on the tubular 20 are engaged with threads 42 in the coupling 22 in this example. The rotary clamp 24 grips the tubular 20 with jaws 34, and then a rotor 32 rotates the tubular 20 to thereby thread the tubular into the coupling 22, until the tubular contacts a shoulder 46 in the coupling. In other examples, the shoulder 46 may be positioned at different locations in the coupling 22 or other threaded component.

While the tubular 20 is being rotated by the rotary clamp 24 and the torque is being applied to the tubular, a torque sensor 44 produces measurements over time of the applied torque. In this example, the torque measurements are evaluated in real time (while the tubular 20 is being rotated by the rotary clamp 24) to determine if any anomalous torque occurrence happens. In this manner, the threaded connection process can be stopped if an anomalous torque occurrence happens (prior to the threaded connection being fully made-up), thereby saving time that would be otherwise wasted if the process continued, and preventing damage to components of the system 10 (such as the rotor 32 and jaws 34).

As depicted in FIG. 2B, the tubular 20 has been threaded into the coupling 22 a sufficient distance, so that the tubular contacts the shoulder 46. The rotary clamp 24 may continue to apply torque to the tubular 20 after the tubular has contacted the shoulder 46, until a predetermined maximum torque value is achieved. At this point, the threaded connection is fully made-up, the torque is relieved and the rotary clamp 24 is released from the tubular 20.

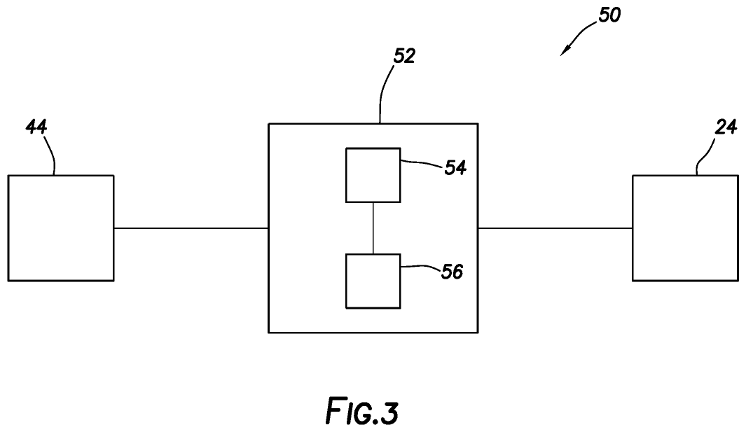

Referring additionally now to FIG. 3, an example of a control system 50 that may be used with the system 10 and method of FIGS. 1-2B is representatively illustrated in schematic form. The control system 50 is used in this example to control operation of the rotary clamp 24 in the threaded connection make-up process.

As depicted in FIG. 3, the control system 50 includes a controller 52. The controller 52 receives the torque measurements produced by the torque sensor 44 over time and outputs signals for controlling operation of the rotary clamp 24 during the threaded connection make-up process. The output signals can cause the rotary clamp 24 to continue to apply torque to the tubular 20, or the output signals can cause the rotary clamp 24 to cease applying torque to the tubular.

The controller 52 in this example can include at least a memory 54 for storing the torque measurements produced by the torque sensor 44 and a device 56 for evaluating the torque measurements. The device 56 can comprise a neural network, an artificial intelligence device, machine learning, a genetic algorithm and/or any combination of these or other devices. The device 56 can be in the form of software, computer instructions or program, etc.

The controller 52 can also include a variety of other components (such as, a processor, a power supply, one or more input devices, one or more output devices, etc.). Any component of the controller 52 may be implemented in hardware and/or software. The scope of this disclosure is not limited to any particular configuration of the controller 52.

The device 56 is programmed and/or trained to detect an anomalous torque occurrence in the torque measurements received from the torque sensor 44. For example, a neural network can be trained to recognize and distinguish between an acceptable torque versus time curve and an unacceptable torque versus time curve. Samples of unacceptable torque versus time curves can be identified as such to the neural network, so that the neural network learns to detect when anomalous torque occurrences are present in the unacceptable torque versus time curves. Persons of ordinary skill in the machine learning, neural network training and artificial intelligence art are aware of such techniques, and so these techniques are not described in further detail herein.

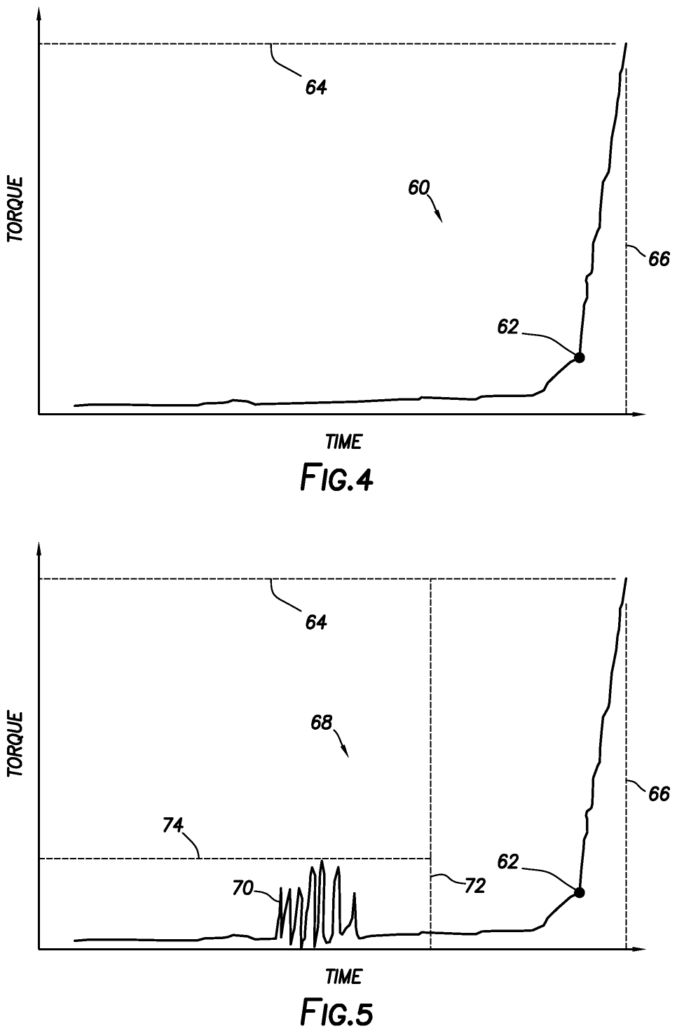

Referring additionally now to FIG. 4, an example graph of a typical torque versus time curve 60 for a threaded connection make-up is representatively illustrated. The torque versus time curve 60 represents measured torque values or torque measurements over time during the process of making-up the threaded connection. However, it should be clearly understood that the torque versus time curve 60 of FIG. 4 is merely one example, a variety of other different examples are possible, and so the scope of this disclosure is not limited to any details of the FIG. 4 torque versus time curve.

As depicted in FIG. 4, the measured torque value gradually increases over time during a majority of the threaded connection make-up process. Thus, an initial slope of the curve 60 is relatively low as the torque measurements gradually and relatively smoothly increase over time.

The slope of the curve 60 begins to increase as the tubular 20 begins to contact the shoulder 46 in the coupling 22 (see FIGS. 2A & B). At a point 62, the tubular 20 is fully abutting the shoulder 46, and so the slope sharply increases thereafter.

When a predetermined maximum torque value 64 is achieved, the threaded connection process is terminated (the torque applied to the tubular 20 is relieved and the jaws 34 are released from the tubular). For example, the predetermined maximum torque value 64 can be stored in the memory 54 of the controller 52, so that the controller will produce an appropriate output signal to cause the rotary clamp 24 to cease the application of torque when the torque as measured by the torque sensor 44 increases to the predetermined maximum torque.

Note that the predetermined maximum torque 64 occurs at a certain time 66 in the FIG. 4 example. A neural network, artificial intelligence device, machine learning device, genetic algorithm or other type of device 56 trained using the torque versus time curve 60 and similar acceptable torque versus time curves will recognize that the sharply increased slope occurring just prior to the time 66 would be anomalous if it had occurred well prior to that time. The trained device 56 will also recognize the typical shape of the curve 60, with a distinct inflection in the slope at the shouldered-up point 62. The trained device 56 will also recognize that an acceptable torque versus time curve will include a gradual increase (relatively smooth slope) in the initial majority of the torque versus time curve.

Referring additionally now to FIG. 5, an example graph of an anomalous torque versus time curve 68 for a threaded connection make-up is representatively illustrated. The torque versus time curve 68 represents measured torque values or torque measurements over time during the process of making-up the threaded connection. However, it should be clearly understood that the torque versus time curve 68 of FIG. 5 is merely one example of an anomalous torque versus time curve, a variety of other different examples are possible, and so the scope of this disclosure is not limited to any details of the FIG. 5 torque versus time curve.

The FIG. 5 torque versus time curve 68 is similar in many respects to the FIG. 4 torque versus time curve 60. However, the FIG. 5 torque versus time curve 68 includes an anomalous torque occurrence 70 during an initial period of time in which it would otherwise be expected that the torque value would be gradually increasing.

A neural network, artificial intelligence device, machine learning device, genetic algorithm or other type of device 56 trained using the anomalous torque versus time curve 68 and similar unacceptable torque versus time curves will recognize that the sharply increased slope at initiation of the anomalous torque occurrence (and other sharply increased slopes during the anomalous torque occurrence) is substantially prior to the time 66 at which a significant slope increase is expected, and does not occur after the shouldered-up point 62. The trained device 56 will also recognize the curve 68 does not have the typical shape of an acceptable torque versus time curve. The trained device 56 will also recognize that a frequency of the curve is atypical at the anomalous torque occurrence 70. The trained device 56 will also recognize that the slope of the curve 68 includes sharp decreases during the anomalous torque occurrence 70.

In actual practice, when the device 56 detects an anomalous torque occurrence 70 in the torque measurements output by the torque sensor 44, the controller 52 will in response output an appropriate signal to cause the rotary clamp 24 to cease application of torque to the tubular 20. Due to processing delay, it is expected that the application of torque will cease, for example, at a time 72 that is after the initiation of the anomalous torque occurrence 70.

However, note that the difference between the times 66, 72 is saved by ceasing the application of torque as soon as practical after detection of the anomalous torque occurrence 70. In addition, if the application of torque is ceased at the time 72, the maximum applied torque value 74 in this example is much less than the predetermined maximum torque value 64 that would otherwise be applied to the tubular 20. Thus, wear and possible damage to the tubular 20 and equipment (such as, the jaws 34 and rotor 32) is avoided.

FIG. 5 depicts the torque versus time curve 68 as if the application of torque is not ceased at the time 72, but instead is applied until the predetermined maximum torque 64 is achieved. This is because the curve 68 is an example of an anomalous torque versus time curve that might be used to train the device 56. However, it will be appreciated that, using the principles disclosed herein, the application of torque can be ceased soon after the anomalous torque occurrence 70 is detected (for example, at time 72), in which case the remainder of the curve 68 would not be produced in actual practice.

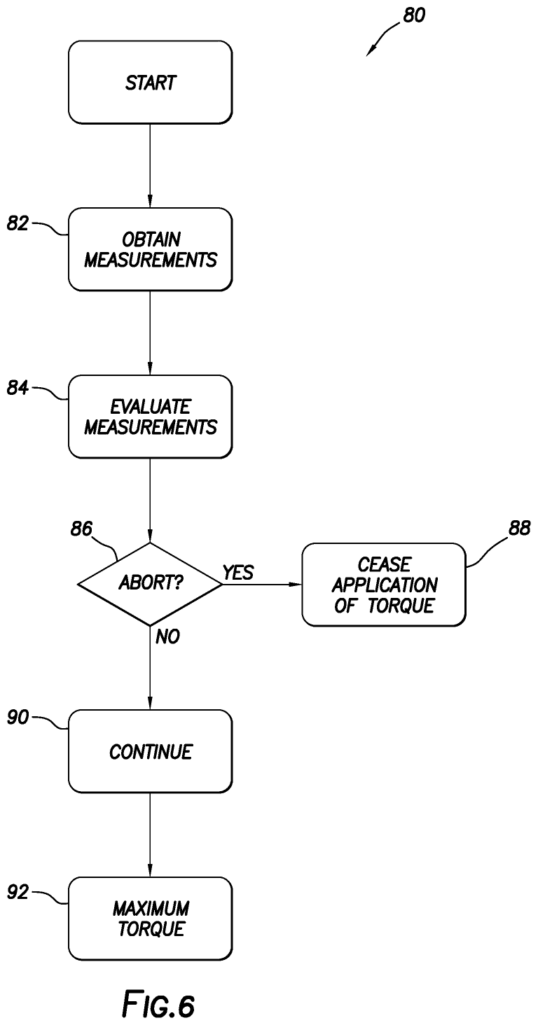

Referring additionally now to FIG. 6, a flowchart for an example of a method 80 of making-up a threaded connection is representatively illustrated. The method 80 may be used with the system 10 described above, or it may be used with other systems.

In the FIG. 6 example, upon starting the threaded connection make-up method 80, in step 82 torque measurements are obtained over time while the threaded connection is being made-up. In the system 10, the torque measurements are output by the torque sensor 44 and are stored in the memory 54 of the controller 52.

In step 84, the measured torque values over time are evaluated by the device 56. This step 84 is performed in real time, as the torque measurements become available in the memory 54 for such evaluation and while the tubular 20 is being rotated by the rotary clamp 24.

The device 56 may detect an anomalous torque frequency, an anomalous slope, a predetermined torque value (such as the torque value 74) prior to a predetermined time (such as the time 66), an anomalous torque decrease and/or an anomalous torque variation in the measured torque values, as an indication that an anomalous torque occurrence 70 has happened.

The device 56 is previously trained or programmed to detect anomalous torque occurrences in torque versus time data. In one technique, a neural network can be trained by inputting to the neural network examples identified as typical acceptable torque versus time curves (such as the FIG. 4 curve 60) and examples identified as anomalous unacceptable torque versus time curves (such as the FIG. 5 curve 68).

In another technique, the neural network can be programmed to cluster the torque versus time examples into many groups. In this technique, all data is presented to the neural network, and the neural network itself finds structures in the data. Once the clustering is done, each cluster can be identified as acceptable or unacceptable.

In step 86, a decision is made whether to abort the threaded connection make-up. If the device 56 has detected an anomalous torque occurrence (such as the anomalous torque occurrence 70 depicted in FIG. 5), the decision to abort is “yes” and application of the torque is ceased in step 88. If the device 56 has not detected an anomalous torque occurrence, the decision to abort is “no” and application of the torque is continued in step 90.

The application of the torque is continued until the predetermined maximum torque value 64 is achieved in step 92. However, note that steps 82, 84, 86, 90 are repeated continuously during the threaded connection make-up, unless an anomalous torque occurrence is detected, at which point the application of torque is ceased.

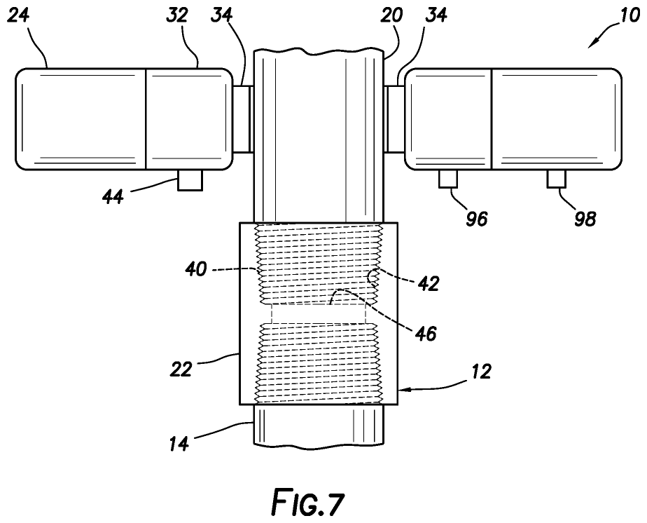

Referring additionally now to FIG. 7, another example of the method of making-up tubular string components is representatively illustrated. In this example, additional sensors 96, 98 are used in the system 10. As depicted in FIG. 7, both of the sensors 96, 98 are associated with or incorporated in the rotary clamp 24, but in other examples the sensors could be provided in other locations.

The sensor 96 is a rotation or turn sensor in the FIG. 7 example. The sensor 96 measures a number of turns of the tubular 20 produced by the rotary clamp 24. In the FIG. 3 control system 50, an output of the sensor 96 can be input to the controller 52, along with the output of the torque sensor 44.

The sensor 98 can be any of a variety or different types of sensors, or a combination of sensors. For example, the sensor 98 may be used to measure environmental conditions, such as, temperature, humidity, etc. In the FIG. 3 control system 50, an output of the sensor 98 can be input to the controller 52, along with the outputs of the torque sensor 44 and turn sensor 96.

In addition, other information or data that may affect the make-up process can be input to the controller 52. For example, the type or model of the rotary clamp 24, maintenance or machine status data, thread lubricant type or level may be input to the controller 52. This information or data, as well as exemplary outputs of the sensors 96, 98 may be used to train the device 56, so that an anomalous torque versus time or torque versus turn curve can be more readily distinguished from an acceptable torque versus time or torque versus turn curve.

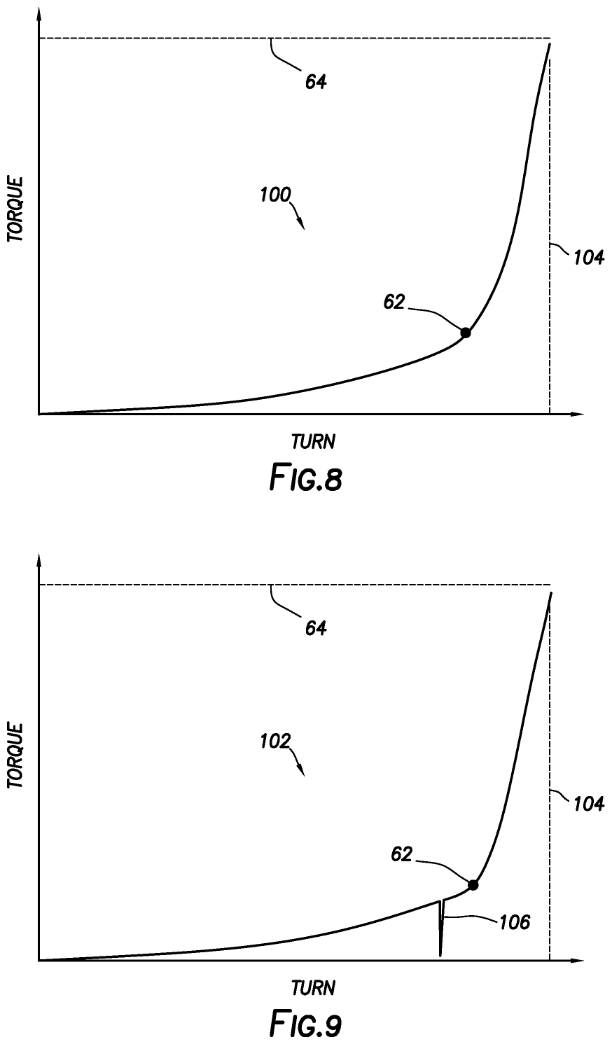

Referring additionally now to FIG. 8, an example graph of a typical torque versus turn curve 100 for a threaded connection make-up is representatively illustrated. The torque versus turn curve 100 represents measured torque values or torque measurements as the tubular 20 is rotated during the process of making-up the threaded connection, for example, using outputs of the sensors 44, 96. However, it should be clearly understood that the torque versus turn curve 100 of FIG. 8 is merely one example, a variety of other different examples are possible, and so the scope of this disclosure is not limited to any details of the FIG. 8 torque versus turn curve.

As depicted in FIG. 8, the measured torque value gradually increases as the tubular 20 is rotated during a majority of the threaded connection make-up process. Thus, an initial slope of the curve 100 is relatively low as the torque measurements gradually and relatively smoothly increase with rotation of the tubular 20.

When the predetermined maximum torque value 64 is achieved, the threaded connection process is terminated (the torque applied to the tubular 20 is relieved and the jaws 34 are released from the tubular). For example, the predetermined maximum torque value 64 can be stored in the memory 54 of the controller 52, so that the controller will produce an appropriate output signal to cause the rotary clamp 24 to cease the application of torque when the torque as measured by the torque sensor 44 increases to the predetermined maximum torque.

Note that the predetermined maximum torque 64 occurs at a certain time 66 in the FIG. 8 example. The neural network, artificial intelligence device, machine learning device, genetic algorithm or other type of device 56 trained using the torque versus turn curve 100 and similar acceptable torque versus turn curves will recognize that the sharply increased slope occurring just prior to a typical number of turns 104 would be anomalous if it had occurred well prior to that amount of rotation. The trained device 56 will also recognize the typical shape of the curve 100, with a distinct inflection in the slope at the shouldered-up point 62. The trained device 56 will also recognize that an acceptable torque versus turn curve will include a gradual increase (relatively smooth slope) in the initial majority of the torque versus turn curve.

Referring additionally now to FIG. 9, an example graph of an anomalous torque versus turn curve 102 for a threaded connection make-up is representatively illustrated. The torque versus turn curve 102 represents measured torque values or torque measurements as the tubular 20 is rotated during the process of making-up the threaded connection. However, it should be clearly understood that the torque versus turn curve 102 of FIG. 9 is merely one example of an anomalous torque versus turn curve, a variety of other different examples are possible, and so the scope of this disclosure is not limited to any details of the FIG. 9 torque versus turn curve.

The FIG. 9 torque versus turn curve 102 is similar in many respects to the FIG. 8 torque versus turn curve 100. However, the FIG. 9 torque versus turn curve 102 includes an anomalous torque occurrence 106 during an initial period of time in which it would otherwise be expected that the torque value would be gradually increasing.

A neural network, artificial intelligence device, machine learning device, genetic algorithm or other type of device 56 trained using the anomalous torque versus turn curve 102 and similar unacceptable torque versus turn curves will recognize that a sharp decrease in torque followed by a sharp increase in torque as in the anomalous torque occurrence 106 indicates that the make-up process is unacceptable. In other types of unacceptable or anomalous torque versus turn curves, a sharply increased slope at initiation of an anomalous torque occurrence (and other sharply increased slopes during the anomalous torque occurrence) may be substantially prior to a number of turns at which a significant slope increase is expected, and not after the shouldered-up point 62. The trained device 56 in some cases may recognize that the curve 102 does not have the typical shape of an acceptable torque versus turn curve. The trained device 56 in other examples may recognize that a frequency of the curve is atypical at the anomalous torque occurrence 70.

In actual practice, when the device 56 detects an anomalous torque occurrence 106 in the torque measurements output by the torque sensor 44, the controller 52 will in response output an appropriate signal to cause the rotary clamp 24 to cease application of torque to the tubular 20. Due to processing delay, it is expected that the application of torque will cease, for example, at a quantity of turns that is after the initiation of the anomalous torque occurrence 106.

However, the ceasing of the application of torque is performed as soon as practical after detection of the anomalous torque occurrence 106. In addition, if the application of torque is promptly ceased, the maximum applied torque value will be much less than the predetermined maximum torque value 64 that would otherwise be applied to the tubular 20. Thus, wear and possible damage to the tubular 20 and equipment (such as, the jaws 34 and rotor 32) is avoided.

FIG. 9 depicts the torque versus turn curve 102 as if the application of torque is not ceased promptly after the anomalous torque occurrence 106, but instead is applied until the predetermined maximum torque 64 is achieved. This is because the curve 102 is an example of an anomalous torque versus turn curve that might be used to train the device 56. However, it will be appreciated that, using the principles disclosed herein, the application of torque can be ceased soon after the anomalous torque occurrence 106 is detected, in which case the remainder of the curve 102 would not be produced in actual practice.

It will be appreciated by those skilled in the art that, if the rotary clamp 24 rotates the tubular 20 at a constant speed (e.g., revolutions per minute), then a torque versus time curve is equivalent to a torque versus turn curve for the threaded connection make-up process. However, where the speed of rotation varies, there can be an advantage to evaluating torque versus turn data in addition to, or instead of, torque versus time data for determining whether an anomalous torque has occurred during the make-up process.

In the FIG. 6 example of the method 80, the torque and turn data output by the sensors 44, 96 can be used to evaluate the progress of the make-up process. In step 82, torque measurements are obtained during rotation of the tubular 20 while the threaded connection is being made-up. In the system 10, the torque measurements are output by the torque sensor 44, the turn measurements are output by the turn sensor 96, and these measurements are stored in the memory 54 of the controller 52.

In step 84, the measured torque and turn values are evaluated by the device 56. This step 84 is performed in real time, as the torque and turn measurements become available in the memory 54 for such evaluation and while the tubular 20 is being rotated by the rotary clamp 24. Outputs of the sensor 98 and other information and data (such as, the type or model of the rotary clamp 24, maintenance or machine status data, thread lubricant type or level, etc.) may also be input and stored in the memory 54 for use in evaluating the threaded connection make-up process.

The device 56 may detect an anomalous torque frequency, an anomalous slope, a predetermined torque value (such as the torque value 74) prior to a predetermined time (such as the time 66), an anomalous torque decrease and/or an anomalous torque variation in the measured torque values, as an indication that an anomalous torque occurrence 70, 106 has happened.

The device 56 is previously trained or programmed to detect anomalous torque occurrences in torque versus time or torque versus turn data. In one technique, a neural network can be trained by inputting to the neural network examples identified as typical acceptable torque versus time or torque versus turn curves (such as the FIG. 4 curve 60 or the FIG. 8 curve 100) and examples identified as anomalous unacceptable torque versus time or torque versus turn curves (such as the FIG. 5 curve 68 or the FIG. 9 curve 102).

In another technique, the neural network can be programmed to cluster the torque versus time or torque versus turn examples into many groups. In this technique, all data is presented to the neural network, and the neural network itself finds structures in the data. Once the clustering is done, each cluster can be identified as acceptable or unacceptable.

In step 86, a decision is made whether to abort the threaded connection make-up. If the device 56 has detected an anomalous occurrence in the data (such as the anomalous torque occurrence 70 depicted in FIG. 5 or the anomalous torque occurrence 106 depicted in FIG. 9), the decision to abort is “yes” and application of the torque is ceased in step 88. If the device 56 has not detected an anomalous torque occurrence, the decision to abort is “no” and application of the torque is continued in step 90.

The application of the torque is continued until the predetermined maximum torque value 64 is achieved in step 92. However, note that steps 82, 84, 86, 90 are repeated continuously during the threaded connection make-up, unless an anomalous occurrence is detected in the data, at which point the application of torque is ceased.

It may now be fully appreciated that the above disclosure provides significant advancements to the art of making-up threaded connections in tubular strings. In examples described above, a threaded connection make-up process can be terminated immediately and automatically upon detecting an anomalous torque occurrence, without a need for human intervention. Thus, time can be saved, and wear and damage to equipment can be avoided.

The above disclosure provides to the art a method 80 of making-up a threaded connection (for example, between tubulars 14, 20) for use with a subterranean well. In one example, the method can comprise: rotating a tubular 20; measuring torque applied to the tubular 20 during the rotating, thereby generating data including measured torque values; detecting an anomalous occurrence 70, 106 in the data during the rotating; and ceasing application of the torque to the tubular 20 in response to the detection of the anomalous occurrence 70, 106.

The measuring step may include measuring turns of the tubular 20 during the rotating. The data may includes measured turn values.

The method may include obtaining information including environmental information (such as, temperature, humidity, etc.), a type of a rotary clamp 24, maintenance information, machine status information, thread lubricant type and/or lubricant level.

The detecting step may be performed by a device 56, which may comprise at least one of a neural network, an artificial intelligence device, machine learning and genetic algorithms.

The step of ceasing application of the torque may be performed automatically in response to detection of the anomalous occurrence 70, 106. The step of ceasing application of the torque can be performed without human intervention in response to detection of the anomalous occurrence 70, 106.

The torque measuring step may be performed using a torque sensor 44 of a rotary clamp 24. The turns measuring step may be performed using a turn sensor 96.

The detecting step can comprise detecting an anomalous torque frequency, an anomalous slope (e.g., a torque versus time slope or a torque versus turn slope), an anomalous torque decrease and/or an anomalous torque variation in the measured torque values. The detecting step can comprise detecting a predetermined torque value prior to a predetermined time (such as the time 66) or predetermined number of turns (such as the turns 104).

Also provided to the art by the above disclosure is a threaded connection make-up system 10 for use with a subterranean well. In one example, the system 10 can comprise: a rotary clamp 24 configured to apply torque to a tubular 20; a torque sensor 44 configured to produce measurements of the torque (and optionally turns) applied to the tubular 20; and a control system 50 including at least one of the group consisting of a neural network, an artificial intelligence device, machine learning and genetic algorithms. The neural network, artificial intelligence device, machine learning and/or genetic algorithms is trained to detect an anomalous occurrence 70, 106 in the measurements.

The control system 50 may be configured to prevent further application of the torque to the tubular 20 in response to detection of the anomalous occurrence 70, 106. The control system 50 may automatically prevent further application of the torque to the tubular 20 in response to detection of the anomalous occurrence 70, 106, without human intervention.

The neural network, artificial intelligence device, machine learning and/or genetic algorithm may be trained to detect an anomalous torque frequency, an anomalous slope (e.g., a torque versus time slope or a torque versus turn slope), an anomalous torque decrease, a predetermined torque value prior to a predetermined time or number of turns, and/or an anomalous torque variation in the torque measurements.

The neural network, artificial intelligence device, machine learning and/or genetic algorithm may be trained to distinguish the anomalous torque occurrence 70 from a shouldered torque profile in the torque measurements. In one example, the shouldered torque profile can correspond to the inflection in the slope of the torque versus time curve 60 or the torque versus turn curve 100 at the shouldered-up point 62 as depicted in FIGS. 4 & 8.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method of making-up a threaded connection for use with a subterranean well, the method comprising:
rotating a tubular;
measuring torque applied to the tubular during the rotating, thereby generating data including measured torque values;
detecting an anomalous occurrence in the data during the rotating; and
ceasing application of the torque to the tubular in response to the anomalous occurrence detecting.

2. The method of claim 1, in which the measuring further comprises measuring turns of the tubular during the rotating, and the data includes measured turn values.

3. The method of claim 1, further comprising obtaining information including at least one of the group consisting of environmental information, a type of a rotary clamp, maintenance information, machine status information, thread lubricant type and lubricant level.

4. The method of claim 1, in which the detecting is performed by at least one of the group consisting of a neural network, an artificial intelligence device, machine learning and genetic algorithms.

5. The method of claim 1, in which the ceasing application of the torque is performed automatically in response to the anomalous occurrence detecting.

6. The method of claim 1, in which the ceasing application of the torque is performed without human intervention in response to the anomalous occurrence detecting.

7. The method of claim 1, in which the torque measuring is performed using a torque sensor of a rotary clamp.

8. The method of claim 1, in which the anomalous occurrence comprises an anomalous slope in the measured torque values.

9. The method of claim 8, in which the anomalous slope comprises at least one of the group consisting of a torque versus time slope and a torque versus turn slope.

10. The method of claim 1, in which the anomalous occurrence comprises at least one of the group consisting of a) an anomalous torque frequency in the measured torque values, b) an anomalous torque decrease in the measured torque values, c) a predetermined torque value prior to a predetermined time or a predetermined number of turns of the tubular, d) a predetermined torque value prior to a predetermined number of turns of the tubular and e) an anomalous torque variation in the measured torque values.

11. A threaded connection make-up system for use with a subterranean well, the system comprising:
a rotary clamp configured to apply torque to a tubular;
a torque sensor configured to produce measurements of the torque applied to the tubular; and
a control system including at least one of the group consisting of a neural network, an artificial intelligence device, machine learning and genetic algorithms,
in which the at least one of the group consisting of the neural network, the artificial intelligence device, the machine learning and the genetic algorithms is trained to detect an anomalous occurrence in the torque measurements.

12. The system of claim 11, in which the control system receives information including at least one of the group consisting of environmental information, a type of a rotary clamp, maintenance information, machine status information, thread lubricant type and lubricant level.

13. The system of claim 11, further comprising a turn sensor configured to produce measurements of rotation of the tubular.

14. The system of claim 11, in which the control system is configured to prevent further application of the torque to the tubular in response to detection of the anomalous occurrence.

15. The system of claim 11, in which the control system automatically prevents further application of the torque to the tubular in response to detection of the anomalous occurrence.

16. The system of claim 11, in which the control system prevents further application of the torque to the tubular in response to detection of the anomalous torque, without human intervention.

17. The system of claim 11, in which the anomalous occurrence comprises at least one of the group consisting of a) an anomalous torque frequency in the torque measurements, b) an anomalous torque decrease in the torque measurements, c) a predetermined torque value prior to a predetermined time, d) a predetermined torque value prior to a predetermined number of turns of the tubular and e) an anomalous torque variation in the torque measurements.

18. The system of claim 11, in which the anomalous occurrence comprises an anomalous slope in the torque measurements.

19. The system of claim 18, in which the anomalous slope comprises at least one of the group consisting of a torque versus time slope and a torque versus turn slope.

20. The system of claim 11, in which the at least one of the group consisting of the neural network, the artificial intelligence device, the machine learning and the genetic algorithms is trained to distinguish the anomalous occurrence from a shouldered torque profile in the torque measurements.
